(19) United States
(12) Patent Application Publication
(10) Pub. No.: US 2024/0403726 A1
(43) Pub. Date: Dec. 5, 2024

(54) SYSTEMS AND METHODS FOR IDENTIFYING MARKOV DECISION PROCESS SOLUTIONS

(71) Applicant: International Business Machines Corporation, Armonk, NY (US)

(72) Inventors: Long Vu, Chappaqua, NY (US); Alexander Zadorojniy, Haifa (IL); Dharmashankar Subramanian, Rye Brook, NY (US)

(21) Appl. No.: 18/327,156

(22) Filed: Jun. 1, 2023

(51) Int. Cl. G06N 20/20

(52) U.S. Cl. CPC G06N 20/20

(57) ABSTRACT

Disclosed embodiments may include a system for identifying Markov Decision Process (MDP) solutions. The system may receive input data including one or more first states and one or more first actions. The system may identify, via a machine learning model (MLM), a subset of the input data. The system may formulate, via the MLM, a search space based on the subset of the input data, the search space including one or more second states and one or more second actions. The system may conduct, via the MLM, hyperparameter tuning of the search space. The system may generate, via the MLM, an MDP instance based on the hyperparameter tuning. The system may determine, via the MLM, whether the generated MDP instance includes a first MDP solution.

### BACKGROUND

The present invention relates to systems and methods for identifying and evaluating Markov Decision Process (MDP) solutions.

Traditional systems and methods for identifying MDP solutions typically involve using heuristics to graph and select a series of steps to perform. These traditional systems and methods require a large domain of knowledge such that they may be applied in a variety of end use applications.

Accordingly, there is a need for improved systems and methods for identifying MDP solutions. Embodiments of the present disclosure may be directed to this and other considerations.

### SUMMARY

According to an embodiment of the present invention, a system may include one or more processors, and memory in communication with the one or more processors and storing instructions that, when executed by the one or more processors, are configured to cause the system to identify one or more MDP solutions. The system may receive input data including one or more first states and one or more first actions. The system may identify, via a machine learning model (MLM), a subset of the input data. The system may formulate, via the MLM, a search space based on the subset of the input data, the search space including one or more second states and one or more second actions. The system may conduct, via the MLM, hyperparameter tuning of the search space. The system may generate, via the MLM, an MDP instance based on the hyperparameter tuning. The system may determine, via the MLM, whether the generated MDP instance includes a first MDP solution. The system may conduct the above-mentioned steps iteratively until one or more MDP solutions are identified.

Additional embodiments of the present invention may incorporate one or more of the above-mentioned steps, however, in a different form, such as a computer program product or a computer-implemented method.

This summary is provided to introduce a selection of concepts in a simplified form that are further described below in the detailed description. This summary is not intended to identify key features or essential features of the claimed subject matter, nor is it intended to be used to limit the scope of the claimed subject matter. Additional features and advantages of the disclosed technology will be made apparent from the following detailed description of illustrative embodiments that proceeds with reference to the accompanying drawings.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a block diagram of an example computing environment used to identify MDP solutions, according to certain embodiments of the disclosed technology.

FIG. 2 is a block diagram of an example MDP solution identification module used to identify MDP solutions, according to certain embodiments of the disclosed technology.

FIG. 3 is a flow diagram illustrating an exemplary method for identifying MDP solutions, according to certain embodiments of the disclosed technology.

### DETAILED DESCRIPTION

Traditional systems and methods for identifying MDP solutions typically involve using heuristics to graph and select a series of steps to perform, and are typically limited in terms of a maximal state size of around 10,000 states and 100 actions. These traditional systems and methods require a large domain of knowledge, which may not be easily applied to any type of end use application. Additionally, these systems and methods are not typically scalable and are thus limited in terms of the end use application scale in which they may be applied. First, MDP is well suited for medium-sized problems, which typically have no more than 10,000 states. Second, annotated knowledge is required for the system to understand input states and actions. Thus, for a system with a large-scale input of states and actions (e.g., greater than 10,000 states and/or greater than 100 actions), a larger amount of domain knowledge is required by the users, which is not feasible in many applications and real-life use cases. For example, annotation of 10,000 states in a JSON file is tedious and error prone.

Accordingly, examples of the present disclosure may provide for receiving input data including states, actions, and/or binning strategies, utilizing a predictive model to select important input data such that a reduced search space may be generated and used in subsequent steps, performing hyperparameter tuning of the search space, and iteratively generating and evaluating MDP instances such that one or more MDP solutions may be identified.

Disclosed embodiments may employ machine learning models (MLMs), among other computerized techniques, to formulate an appropriate search state based on input data and a given process, and conduct hyperparameter tuning of such search state to thereby identify MDP instances and solutions. Machine learning models are a unique computer technology that involves training models to complete tasks and make decisions. These techniques may help to improve database and network operations. For example, the systems and methods described herein may utilize, in some instances, MLMs, which are necessarily rooted in computers and technology, to evaluate generated MDP instances to identify MDP solutions. This, in some examples, may involve using state, action, and/or binning strategy input data and an MLM, applied to formulate and/or reduce a search state to be used in identifying MDP solutions. Using an MLM and a computer system configured in this way may allow the system to generate MDP solutions iteratively and automatically through performing configuration generation, search, and hyperparameter optimization on MDP configuration candidates.

This may provide an advantage and improvement over prior technologies that may not provide a scalable system, or such a search state configuration for automatic and widely applicable MDP solution identification, which may be solved by the present disclosure. Furthermore, examples of the present disclosure may also improve the speed with which computers can identify and evaluate MDP solutions. Overall, the systems and methods disclosed have significant practical applications in the MDP field because of the noteworthy improvements in search space formulation, and hyperparameter tuning of MDP configuration candidates, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

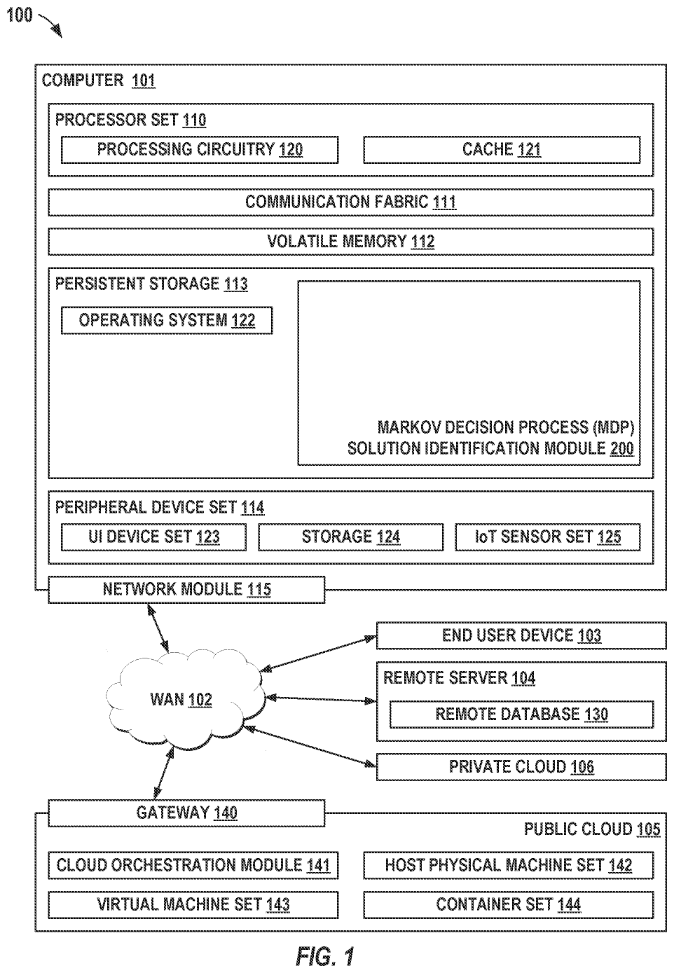

With reference now to FIG. 1, computing environment 100 contains an example of an environment for the execution of at least some of the computer code involved in performing the inventive methods, such as MDP solution identification module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

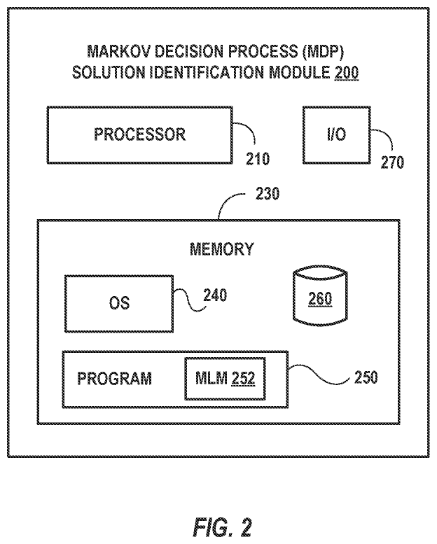

With reference now to FIG. 2, an example MDP solution identification module 200 is used to identify MDP solutions according to an example implementation of the disclosed technology. According to some embodiments, one or more features of MDP solution identification module 200, as further discussed below, may have structures and/or components that are similar to those described above with respect to computing environment 100 shown in FIG. 1.

As shown, the MDP solution identification module 200 may include a processor 210, an input/output (I/O) device 270, a memory 230 containing an operating system (OS) 240 and a program 250. In some embodiments, program 250 may include an MLM 252 that may be trained, for example, to formulate a search space and utilize such search space in the automatic identification and evaluation of MDP solutions. In certain implementations, MLM 252 may issue commands in response to processing an event, in accordance with a model that may be continuously or intermittently updated. Moreover, processor 210 may execute one or more programs (such as via a rules-based platform or the trained MLM 252), that, when executed, perform functions related to disclosed embodiments.

In certain example implementations, the MDP solution identification module 200 may be a single server or may be configured as a distributed computer system including multiple servers or computers that interoperate to perform one or more of the processes and functionalities associated with the disclosed embodiments. In some embodiments MDP solution identification module 200 may be one or more servers from a serverless or scaling server system. In some embodiments, the MDP solution identification module 200 may further include a peripheral interface, a transceiver, a mobile network interface in communication with the processor 210, a bus configured to facilitate communication between the various components of the MDP solution identification module 200, and a power source configured to power one or more components of the MDP solution identification module 200.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a USB, a micro-USB port, a high-definition multimedia interface (HDMI) port, a video port, an audio port, a Bluetooth™ port, an NFC port, another like communication interface, or any combination thereof.

In some embodiments, a transceiver may be configured to communicate with compatible devices and ID tags when they are within a predetermined range. A transceiver may be compatible with one or more of: radio-frequency identification (RFID), NFC, Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 210 to communicate with other devices via wired or wireless networks, whether local or wide area, private or public, as known in the art. A power source may be configured to provide an appropriate alternating current (AC) or direct current (DC) to power components.

The processor 210 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 210 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 210 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 210 may be a single core processor that is configured with virtual processing technologies. In certain embodiments, the processor 210 may use logical processors to simultaneously execute and control multiple processes. The processor 210 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the MDP solution identification module 200 may include one or more storage devices configured to store information used by the processor 210 (or other components) to perform certain functions related to the disclosed embodiments. In one example, the MDP solution identification module 200 may include the memory 230 that includes instructions to enable the processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The MDP solution identification module 200 may include a memory 230 that includes instructions that, when executed by the processor 210, perform one or more processes consistent with the functionalities disclosed herein. Methods, systems, and articles of manufacture consistent with disclosed embodiments are not limited to separate programs or computers configured to perform dedicated tasks. For example, the MDP solution identification module 200 may include the memory 230 that may include one or more programs 250 to perform one or more functions of the disclosed embodiments. For example, in some embodiments, the MDP solution identification module 200 may additionally manage dialogue and/or other interactions with a user via a program 250.

The processor 210 may execute one or more programs 250 located remotely from the MDP solution identification module 200. For example, the MDP solution identification module 200 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 210, perform one or more processes consistent with the disclosed embodiments. In some embodiments, the memory 230 may include a database 260 for storing related data to enable the MDP solution identification module 200 to perform one or more of the processes and functionalities associated with the disclosed embodiments.

The database 260 may include stored data relating to status data (e.g., average session duration data, location data, idle time between sessions, and/or average idle time between sessions) and historical status data. According to some embodiments, the functions provided by the database 260 may also be provided by a database that is external to the MDP solution identification module 200.

The MDP solution identification module 200 may also be communicatively connected to one or more memory devices (e.g., databases) locally or through a network. The remote memory devices may be configured to store information and may be accessed and/or managed by the MDP solution identification module 200. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The MDP solution identification module 200 may also include one or more I/O devices 270 that may comprise one or more interfaces for receiving signals or input from devices and providing signals or output to one or more devices that allow data to be received and/or transmitted by the MDP solution identification module 200. For example, the MDP solution identification module 200 may include interface components, which may provide interfaces to one or more input devices, such as one or more keyboards, mouse devices, touch screens, track pads, trackballs, scroll wheels, digital cameras, microphones, sensors, and the like, that enable the MDP solution identification module 200 to receive data from a user (such as, for example, via EUD 103).

In examples of the disclosed technology, the MDP solution identification module 200 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The MDP solution identification module 200 may contain programs that train, implement, store, receive, retrieve, and/or transmit one or more MLMs. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The MDP solution identification module 200 may be configured to adjust model parameters during training. Model parameters may include weights, coefficients, offsets, or the like. Training may be supervised or unsupervised.

The MDP solution identification module 200 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like.

The MDP solution identification module 200 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, MDP solution identification module 200 may be configured to generate a similarity metric representing a measure of similarity between data in a dataset. A similarity metric may be based on a correlation, covariance matrix, a variance, a frequency of overlapping values, or other measure of statistical similarity.

The MDP solution identification module 200 may contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via weighted connections. Prediction models may additionally or alternatively include classification and regression trees, or other types of models known to those skilled in the art. To generate prediction models, the asset detection system may analyze information applying machine-learning methods.

While the MDP solution identification module 200 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the MDP solution identification module 200 may include a greater or lesser number of components than those illustrated.

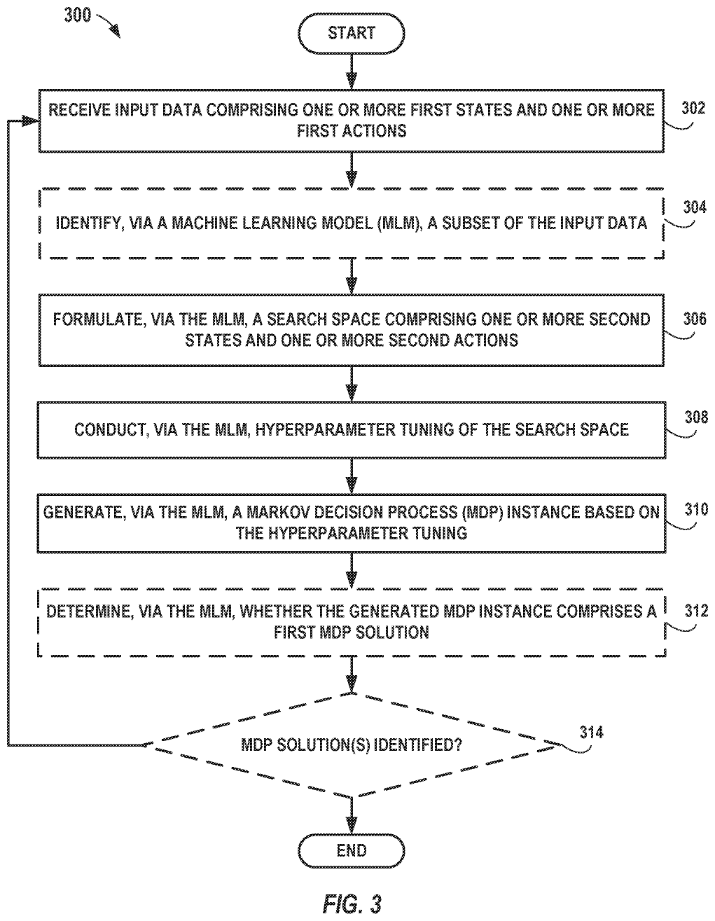

FIG. 3 is a flow diagram illustrating an exemplary method 300 of identifying MDP solutions according to an example implementation of the disclosed technology. The steps of method 300 may be performed by one or more components of computing environment 100, e.g., MDP solution identification module 200, as described above with respect to FIGS. 1 and 2. While certain blocks may be identified as being optional, certain embodiments may omit blocks even if they are not necessarily identified as being optional.

In block 302, the MDP solution identification module 200 may receive input data comprising one or more first states and one or more first actions. In some embodiments, the input data may be received by a user via, for example, a graphical user interface (GUI), a web-based interface or browser, or a JSON file format. A state may correspond to a current status of an application, such as, for example, a current inventory of stock. An action may correspond to a step to take with respect to the state, for example, a step of ordering a certain number of products based on the current stock inventory and expected customer demand for inventory. In some embodiments, a plurality of states and actions may be received, for example, a user may specify a plurality of pairings of states along with corresponding actions for feeding as inputs into a predictive model, as further discussed below. In some embodiments, the input data may further comprise one or more binning strategies, such as methods for grouping the number of states and/or actions for the model to evaluate (e.g., as a range of numbers). Other types of binning strategies may include binning sizes following a uniform distribution (or all bin sizes are equally spaced, e.g., 2, 4, 6, 8), a geometric series (e.g., 2, 4, 8, 16), etc. Moreover, the system can support custom bin sizes—for example, users can specify 10 bins of different sizes. In certain embodiments where binning strategies are not included in the input data, uniformed binning strategies may be applied to the received state(s) and action(s). In some embodiments, the input data may be annotated such that a user may indicate which input values correspond to states, actions, and/or binning strategies, and how each is associated with any of the others.

In some embodiments, the input data may be received dynamically such that as a user, for example, inputs new and/or additional input data, the MDP solution identification module 200 may iteratively and dynamically ingest and process the input data to output new or modified MDP solutions or actions in real-time, as discussed herein.

In optional block 304, the MDP solution identification module 200 may identify, via an MLM, a subset of the input data. In some embodiments, the model may be trained to ingest the input data, as discussed above, and select important states, actions, and/or binning strategies so as to reduce the overall search state area, as further discussed below. In some embodiments, the model may be trained to ingest the input data, as discussed above, and select important states, actions, and/or binning strategies. For example, the model may be trained to rank the input data based on, for example, applicability or relevance to the specific problem or application, and reduce the search state area to include only a certain grouping or subset of the input data to further evaluate. A benefit of such search state reduction is that it may aid in increasing accuracy or reliability of the resulting identified MDP solutions, as further discussed below.

In some embodiments, the MLM may include a predictive model (e.g., Random Forest, Decision Tree, etc.), may be built based on original states (e.g., not binned), or binned states, and/or may be configured to output a target end action, as further discussed herein. In some embodiments, the model may be trained to accept a transformed state search space via feature transformation (e.g., Principal Component Analysis (PCA)). In some embodiments, temporal dependencies in the input data (or subset of the input data) may be removed or smoothed by converting original states into a windowed tabular with certain look back window sizes. Once the model is constructed, its feature importance vector may be used to filter out less important states (e.g., to identify the subset of input data, as discussed above), such that the remaining states (e.g., subset of input data) may be input into subsequent processing steps.

In block 306, the MDP solution identification module 200 may formulate, via the MLM, a search space based on the subset of the input data, the search space comprising one or more second states and one or more second actions. In some embodiments, the search state may include the grouping or area of data (e.g., input data, or subset of the input data) the model is trained to evaluate in generating MDP instances, as further discussed below. As discussed above, in some embodiments, the model may be trained to reduce the search state area based on identifying a subset of the input data for evaluation, such that the second state(s) and second action(s) include a subset of the first state(s) and first action(s) received as input data (block 302). In some embodiments, the search space may be problem- or application-specific.

In block 308, the MDP solution identification module 200 may conduct, via the MLM, hyperparameter tuning of the search space. In some embodiments, this may involve the use of a hyperparameter optimization algorithm (HPO), or a search algorithm configured to generate one or more hyperparameter combinations and train the MLM to utilize the one or more hyperparameter combinations, as further discussed below.

In block 310, the MDP solution identification module 200 may generate, via the MLM, an MDP instance based on the hyperparameter tuning. In some embodiments, the model may provide a matrix score indicating the performance of the generated MDP instance, which may be later used in the determination of whether the MDP instance comprises an MDP solution. When an MDP solution is identified or found (e.g., via the HPO algorithm), the performance of this MDP solution can be evaluated using Fitted Q Evaluation (FQE), as discussed further below. Once FQE is complete, the system may receive a performance score or a performance metric value that shows how good the current MDP solution is. This score may then be used to: (1) improve the search in the subsequent steps, and/or (2) compare different MDP solutions and output the best (top k) ones.

In some embodiments where a search algorithm is utilized, the algorithm may include both a search and evaluation component. With respect to the search component, the algorithm may be utilized to collect a database of configurations and their associated performance metrics (e.g., mean reward), to build an inference model (e.g., Random Forest, K-Nearest Neighbor (KNN), etc.), and to use the built inference model to find the next hyperparameter configuration(s) to evaluate. With respect to the evaluation component, when a new configuration is received from the search component, an MDP instance may be formulated and solved by a solver (e.g., a CPLEX® solver from IBM®). In addition, a Fitted Q Evaluation (FQE) may be used to learn and predict the performance of each MDP instance on a separate test set. FQE may predict the mean reward of each MDP instance on a test set, and each predicted mean reward may be used by the search component to update the database and prepare the next configuration(s). The search component may be configured to find the MDP instance(s) that have the highest mean reward(s) predicted by FQE.

In some embodiments, the hyperparameter tuning or optimization of the search space, as discussed above, may be performed as a parallel search such that multiple MDP instances may be generated (e.g., a single MDP instance per search) and evaluated in a distributed core. In some embodiments, this parallel search may be conducted under a Ray Tune framework.

In optional block 312, the MDP solution identification module 200 may determine, via the MLM, whether the generated MDP instance comprises a first MDP solution. In some embodiments, the MDP solution identification module 200 may receive a specific criterion or criteria, for example, from a user, and use such criteria in the determination step. For example, the specific criteria may provide the system with certain features, characteristics, values, etc., upon which to base a determination as to whether a generated MDP instance should be selected as an MDP solution for purposes of the problem or application at hand.

In optional block 314, the MDP solution identification module 200 may determine whether one or more MDP solutions have been identified. For example, the above-described steps may be part of an iterative process, whereby the system is configured to iteratively run multiple processes so as to generate a single MDP instance and identify a single MDP solution with each process. As another example, parallel processing may be performed, as discussed above.

An example of the disclosed technology will now be illustrated. This example is intended solely for explanatory purposes and not in limitation. An organization may utilize an MDP process for purposes of optimizing vehicle inventory management. A user may input data into a predictive model, such as a current vehicle inventory and a typical and/or anticipated customer demand. The input data may include multiple data points associated with both the inventory and demand based on, for example, geographic region, time of year, etc. For example, the input data may include date, current inventory, expected demand, last order number, and location. The final action generated by the model may be the current order number.

| | | | Last | | Current |
|---|---|---|---|---|---|
| | Current | Expected | Order | | Order |
| Date | Inventory | Demand | Number | Location | Number |
| May 2, 2020 | 124 | 31 | 11 | Chicago | 25 |

The above input tabular data set is then used as the training set for a machine learning predictive model, such as Decision Tree Regression model or Random Forest Regression model. The predictive model receives these input features of date, current inventory, expected demand, last order number, and location, and generates a prediction for current order number. After the prediction model is trained, it ranks the input features based on how important each of the features is with respect to the performance accuracy of the trained predictive model. The less important features, for example date and location, can be removed, and the remaining features are then used as states in the search space. For example, the final set of states may include only current inventory, expected demand, and previous order number. In such example, the final action is still a current order number.

The model may utilize a search algorithm to perform hyperparameter tuning of the subset of input data to generate an MDP instance, and then evaluate the MDP instance to determine whether it constitutes an MDP solution based on certain criteria provided by the user. For example, the user criteria may be the minimum number of cars to be ordered to refill the inventory, e.g., at least 10. In such example, the action the MDP produces may be greater than or equal to 10. Ultimately, the model may output an action for the end user, e.g., an organization, the action being an anticipated number of cars the organization should order to keep up with customer demand. In this example, the output can be an action to order 100 vehicles. The model may be configured to run iteratively such that it provides the organization with multiple MDP solutions. A binning strategy for each state and action may not change after the search space is defined-which is done in the beginning phase of the system. Once the binning strategy is defined and the search space is defined, the best MDP solutions may be found within this search space. In each step of a search, a point in a multidimensional may be found, indicating one MDP candidate solution. The MDP candidate solution may be evaluated by FQE, as discussed above, producing a performance score. Upon generation of the score, the search may be improved upon such that the next point in the search space may be found, indicating another MDP candidate solution. The process may repeat until the system stops. The stop conditions may include, e.g., run time budget, or number of search points. When the search stops, the scores obtained during the search may be used to rank and output the top k MDP final solutions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
one or more processors; and
a memory in communication with the one or more processors and storing instructions that, when executed by the one or more processors, are configured to cause the system to:
iteratively, until one or more Markov Decision Process (MDP) solutions are identified:
receive input data comprising one or more first states and one or more first actions;
identify, via a machine learning model (MLM), a subset of the input data;
formulate, via the MLM, a search space based on the subset of the input data, the search space comprising one or more second states and one or more second actions;
conduct, via the MLM, hyperparameter tuning of the search space;
generate, via the MLM, an MDP instance based on the hyperparameter tuning; and
determine, via the MLM, whether the generated MDP instance comprises a first MDP solution.

2. The system of claim 1, wherein the input data comprises one or more annotated states, one or more first actions, one or more binning strategies, or combinations thereof.

3. The system of claim 1, wherein the MLM comprises a predictive model.

4. The system of claim 3, wherein the MLM is trained to accept a transformed state search space via feature transformation.

5. The system of claim 1, wherein identifying the subset of the input data comprises:
ranking the one or more first states; and
selecting the one or more second states based on the ranked one or more first states.

6. The system of claim 1, wherein the search space further comprises one or more bins configured to reduce a total number of the one or more second states and the one or more second actions thereby reducing an overall search space area.

7. The system of claim 1, wherein the instructions are further configured to cause the system to:
receive, via a graphical user interface (GUI), a user selection of a specific criteria,
wherein determining whether the generated MDP instance comprises the first MDP solution is based on the specific criteria.

8. The system of claim 1, wherein the input data is received via a web-based interface.

9. The system of claim 1, wherein conducting the hyperparameter tuning comprises:
iteratively, via a search algorithm:
generating one or more hyperparameter combinations; and
training the MLM to utilize the one or more hyperparameter combinations.

10. The system of claim 9, wherein generating the one or more hyperparameter combinations is based on a metric produced by performing a Fitted Q Evaluation of the trained MLM.

11. A computer program product for identifying Markov Decision Process (MDP) solutions, the computer program product comprising a computer readable storage medium having program instructions embodied therewith, the program instructions executable by a processor to cause the processor to:
iteratively, until one or more MDP solutions are identified:
receive, by the processor, input data comprising one or more first states and one or more first actions;
formulate, by the processor and via a machine learning model (MLM), a search space based on the input data, the search space comprising one or more second states and one or more second actions;
conduct, by the processor and via the MLM, hyperparameter tuning of the search space;
generate, by the processor and via the MLM, an MDP instance based on the hyperparameter tuning; and
determine, by the processor and via the MLM, whether the generated MDP instance comprises a first MDP solution.

12. The computer program product of claim 11, wherein the program instructions further cause the processor to:
identify, by the processor and via the MLM, a subset of the input data by:
ranking the one or more first states; and
selecting the one or more second states based on the ranked one or more first states,
wherein the search space is based on the subset of the input data.

13. The computer program product of claim 11, wherein conducting the hyperparameter tuning comprises:
iteratively, via a search algorithm:
generating one or more hyperparameter combinations; and
training the MLM to utilize the one or more hyperparameter combinations.

14. The computer program product of claim 13, wherein generating the one or more hyperparameter combinations is based on a metric produced by performing a Fitted Q Evaluation of the trained MLM.

15. The computer program product of claim 11, wherein the search space further comprises one or more bins configured to reduce a total number of the one or more second states and the one or more second actions thereby reducing an overall search space area.

16. A computer-implemented method, comprising:
receiving, by one or more processors, input data comprising one or more first states and one or more first actions;
identifying, via a machine learning model (MLM), a subset of the input data;
formulating, via the MLM, a search space based on the subset of the input data, the search space comprising one or more second states and one or more second actions;
conducting, via the MLM, hyperparameter tuning of the search space; and
generating, via the MLM, a Markov Decision Process (MDP) instance based on the hyperparameter tuning.

17. The computer-implemented method of claim 16, further comprising:
receiving, via a graphical user interface (GUI), a user selection of a specific criteria; and
determining, via the MLM, whether the generated MDP instance comprises a first MDP solution based on the specific criteria.

18. The computer-implemented method of claim 16, wherein the input data is continuously received via a graphical user interface (GUI), and wherein the identifying, formulating, conducting, and generating are conducted dynamically based on the continuously received input data.

19. The computer-implemented method of claim 16, wherein the MLM comprises a predictive model and is trained to accept a transformed state search space via feature transformation.

20. The computer-implemented method of claim 16, wherein the input data is received via a JSON file format.
